(19) United States
(12) Patent Application Publication
(10) Pub. No.: US 2024/0380034 A1
(43) Pub. Date: Nov. 14, 2024

(54) BUTTON CELL AND METHOD OF MANUFACTURING THE SAME

(71) Applicant: VARTA Microbattery GmbH, Ellwangen Jagst (DE)

(72) Inventor: Winfried GAUGLER, Ellwangen (DE)

(21) Appl. No.: 18/656,651

(22) Filed: May 7, 2024

(30) Foreign Application Priority Data
May 13, 2023 (EP) 23173268.6

(51) Int. Cl. H01M 50/109; H01M 10/0525; H01M 10/0587; H01M 50/119; H01M 50/153; H01M 50/181; H01M 50/184; H01M 50/186; H01M 50/536; H01M 50/566

(52) U.S. Cl. CPC H01M 50/109; H01M 10/0525; H01M 10/0587; H01M 50/119; H01M 50/153; H01M 50/181; H01M 50/184; H01M 50/186; H01M 50/536; H01M 50/566

(57) ABSTRACT

An electrochemical energy storage cell in the form of a button cell includes a housing enclosing an interior space in an airtight and liquid-tight manner. The housing includes a metallic, cup-shaped housing part that comprises a housing cup base, a circumferential side wall, and a terminal opening. The housing further includes a lid that closes the terminal opening of the cup-shaped housing part. The electrochemical energy storage cell additionally includes an electrode-separator assembly in the form of a cylindrical winding. The electrode-separator assembly includes a ribbon-shaped anode comprising an anode current collector and a ribbon-shaped cathode comprising a cathode current collector. An inner side of the housing includes a region having a projection directed into the interior space. A first longitudinal edge of the anode current collector or of the cathode current collector is welded to the projection.

### CROSS REFERENCE TO RELATED APPLICATIONS

This application claims benefit to European Patent Application No. EP 23173268.6, filed on May 13, 2023, which is hereby incorporated by reference herein.

### FIELD

The present disclosure relates to an electrochemical energy storage cell in the form of a button cell and to a method of manufacturing the same.

### BACKGROUND

Electrochemical energy storage elements can convert stored chemical energy into electrical energy through virtue of a redox-reaction. The simplest form of an electrochemical energy storage element is the electrochemical cell. It generally comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications, as these cells can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, in particular a metallic foil, which serves as a carrier for the respective active material or the corresponding electrode material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

The composite electrodes can be combined with one or more separators to form an electrode-separator assembly when manufacturing a lithium-ion cell. The electrodes and separators can be connected under pressure or by lamination or bonding. The basic functionality of the cell can then be established by impregnating the assembly with the electrolyte.

In many embodiments, the electrode-separator assembly is formed in the form of a winding or processed into a winding. For example, a ribbon-shaped positive electrode and a ribbon-shaped negative electrode as well as at least one ribbon-shaped separator are fed separately to a winding machine and spirally wound into a winding with the sequence positive electrode/separator/negative electrode. In other cases, a ribbon-shaped positive electrode and a ribbon-shaped negative electrode as well as at least one ribbon-shaped separator are first combined to form an electrode-separator assembly, for example by applying the aforementioned pressure. In a further step, the assembly is rolled up and the electrode-separator assembly formed in this way is placed in a housing and the electrodes are contacted accordingly.

Such energy storage cells with a wound electrode-separator assembly usually have a cylindrical design. A distinction is made between round cells and button cells. Cylindrical round cells are characterized by that their height is greater than their diameter. Button cells have a height that is smaller than their diameter. Button cells generally have much smaller dimensions and capacities than round cells. They are suitable, for example, for powering small electronic devices such as watches, hearing aids, wireless headphones or similar.

Button cells usually have a housing consisting of two metal housing parts. For example, one housing part is cup-shaped (the so-called cell cup) while the other closes the opening of the cup-shaped housing part as a lid. The lid is often also cup-shaped and is inserted into the cell cup with its opening edge first.

The liquid-tight closure of such button cells is achieved, for example, by crimping the edge of the cell cup over an edge or shoulder or circumferential edge of the lid, wherein a plastic ring is arranged between the cell cup and the lid, which is pressed against the shoulder or edge or circumferential edge of the lid by the edge of the cell cup. This plastic ring serves as a sealing element and also insulates the cell cup electrically from the lid.

Alternatively, button cells can also be sealed by holding the cell cup and the lid together in the axial direction exclusively or at least primarily by a force-fit connection, so that crimping can be dispensed with. Such a button cell is known, for example, from DE 10 2009 017 514 A1.

In button cells with metal housing parts, the housing parts usually also act as the poles of the cells. They must therefore be electrically connected to the electrodes. The positive and negative electrodes can be connected to the housing parts in such a way that a strip-shaped electrical conductor is attached to the electrode strips. The strip-shaped electrical conductor of the positive electrode protrudes from one end face of the winding and the strip-shaped electrical conductor of the negative electrode protrudes from the opposite end face of the winding. These conductor strips can be connected to the respective housing parts by welding in order to contact the electrodes electrically. A button cell of this type is shown, for example, in DE 10 2009 060 800 A1.

In JP 2008-262825 A, a secondary button cell with ribbon-shaped electrodes and a ribbon-shaped separator, which together form a cylindrical winding, is described. An electrically insulating plate is arranged on the respective end faces of the winding, which protects the end faces from contact with the housing. The housing consists of a cup-shaped housing part and a lid, wherein the lid is welded into an opening of the cup-shaped housing part. One of the electrodes of the winding is connected to the housing via a metallic arrester, so the housing acts as one pole of the cell. Another arrester is welded directly to a metal pole, which is led out of the housing through a hole in the lid.

Cylindrical round cells having an electrode-separator assembly in the form of a winding and with ribbon-shaped electrodes are known from WO 2017/215900 A1. The electrodes each have current collectors loaded with electrode material. Oppositely polarized electrodes are arranged offset to each other within the electrode-separator assembly so that longitudinal edges of the current collectors of the positive electrodes protrude from one end face and longitudinal edges of the current collectors of the negative electrodes protrude from the other end face of the winding. For electrical contacting of the current collectors, the cell has a contact sheet metal member that sits on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be better dissipated from the winding.

### SUMMARY

In an embodiment, the present disclosure provides an electrochemical energy storage cell in the form of a button cell. The electrochemical energy storage cell includes a housing that encloses an interior space in an airtight and liquid-tight manner. The housing includes a metallic, cup-shaped housing part that comprises a housing cup base, a circumferential side wall, and a terminal opening, wherein the housing cup base and the circumferential side wall each have an inner side facing the interior space and an outer side. The housing further includes a lid that closes the terminal opening of the cup-shaped housing part, wherein the lid has an inner side facing the interior space and an outer side. The electrochemical energy storage cell additionally includes an electrode-separator assembly in the form of a cylindrical winding having a first flat terminal end face, a second flat terminal end face, and a winding shell located between the end faces. The electrode-separator assembly includes a ribbon-shaped anode comprising an anode current collector having a first longitudinal edge and a second longitudinal edge parallel thereto, and a ribbon-shaped cathode comprising a cathode current collector having a first longitudinal edge, a second longitudinal edge parallel to the first longitudinal edge. The anode current collector includes a main region loaded with a layer of negative electrode material and a free edge strip, which extends along the first longitudinal edge of the anode current collector, not loaded with the negative electrode material. Alternatively or in addition, the cathode current collector includes a main region loaded with a layer of positive electrode material and a free edge strip, which extends along the first longitudinal edge of the cathode current collector, not loaded with the positive electrode material. The anode and the cathode are arranged within the electrode-separator assembly such that the first longitudinal edge of the anode current collector protrudes from the first terminal end face and/or the first longitudinal edge of the cathode current collector protrudes from the second terminal end face. The electrode-separator assembly is axially aligned in the housing so that one of the first or the second terminal end face faces the housing cup base and the other of the first or the second terminal end face faces the lid. The first longitudinal edge of the anode current collector or the first longitudinal edge of the cathode current collector abuts directly against a respective inner side, the respective inner side being the inner side of the housing cup base or the inner side of the lid. The respective inner side includes a region having a projection directed into the interior space. The first longitudinal edge of the anode current collector or the first longitudinal edge of the cathode current collector that abuts directly on the respective inner side is welded to the projection.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a perspective view of an embodiment of a housing of a button cell;

FIG. 2 provides a sectional view of a button cell having a housing with beads, such as the housing according to FIG. 1;

FIG. 3 provides a perspective view of a housing of a further embodiment of a button cell;

FIG. 4 provides a sectional view of a button cell having a housing with beads and a pole bushing, such as the button cell housing according to FIG. 3;

FIG. 5A provides a photographic view of a housing cup base of a housing of an energy storage cell;

FIG. 5B provides a photographic view of an end face region of a wound electrode-separator assembly;

FIG. 6A provides a schematic view of a housing cup base of an energy storage cell with three beads and with weld seams in the beads;

FIG. 6B provides a microscopic image of a bead in a housing cup base with three weld seams; and

FIG. 6C provides a microscopic image of a depression region.

### DETAILED DESCRIPTION

Against this background, the present disclosure provides an improved electrochemical energy storage cell in the form of a button cell, which is characterized by a particularly good electrical connection of the electrodes in a winding-shaped electrode-separator assembly. In this cell, the electrochemical potential is to be optimized as far as possible.

Furthermore, the present disclosure provides a method of manufacturing such an electrochemical energy storage cell.

The electrochemical energy storage cell is designed in the form of a button cell and is characterized by the following features a. to j:
a. It comprises a sealed housing, which encloses an interior space in an airtight and liquid-tight manner, and an electrode-separator assembly arranged therein,
b. the housing comprises a metallic, cup-shaped housing part which comprises a housing cup base, a circumferential side wall and a terminal opening, wherein the housing cup base and the circumferential side wall each have an inner side pointing into the interior space and an outer side,
c. the housing comprises a lid which closes the terminal opening of the cup-shaped housing part, wherein the lid has an inner side pointing into the interior space and an outer side,
d. the electrode-separator assembly is in the form of a cylindrical winding, which has a first flat terminal end face and a second flat terminal end face as well as a winding shell located between the end faces,
e. the electrode-separator assembly comprises a ribbon-shaped anode with an anode current collector having a first longitudinal edge and a second longitudinal edge parallel thereto,
f. the electrode-separator assembly comprises a ribbon-shaped cathode with a cathode current collector having a first longitudinal edge and a second longitudinal edge parallel thereto,
g. the anode current collector comprises a main region which is loaded with a layer of a negative electrode material and a free edge strip which extends along its first longitudinal edge and which is not loaded with the electrode material,
and/or
the cathode current collector comprises a main region loaded with a layer of a positive electrode material and a free edge strip extending along its first longitudinal edge which is not loaded with the electrode material,
h. the anode and the cathode are arranged within the electrode-separator assembly in such a way that the first longitudinal edge of the anode current collector protrudes from the first terminal end face and/or the first longitudinal edge of the cathode current collector protrudes from the second terminal end face of the electrode-separator assembly.
i. in the housing, the electrode-separator assembly is axially aligned so that one of the end faces of the winding faces the housing cup base and the other of the end faces faces the lid, and
j. the first longitudinal edge of the anode current collector or the first longitudinal edge of the cathode current collector abuts directly on the inside of the housing cup base or on the inside of the lid.

The button cell is characterized in particular by the following features k. and l:
k. The housing cup base and/or the lid, against the inside of which the first longitudinal edge of the anode current collector or the cathode current collector abuts, has at least one region in which the housing cup base or the lid has a deformation pointing into the interior space, or in which an elevation of the housing cup base or the lid projects into the interior space, and
l. the first longitudinal edge of the anode current collector or the cathode current collector abutting the inside of the housing cup base or the lid is welded to the deformation or to the elevation.

The at least one region in which the housing cup base or the lid has a deformation pointing into the interior space, or in which an elevation of the housing cup base or the lid protrudes into the interior space, is also referred to below as the elevation and/or deformation region. The metallic, cup-shaped housing part is also referred to below as the housing cup.

The particular advantage of this energy storage cell or this button cell is, that at least one of the electrodes is directly contacted to the housing cup base and/or the lid, i.e. to the end face elements of the housing. In contrast to an electrical connection of the electrodes via a separate electrical conductor, as is provided for example in the button cells according to JP 2008-262825 A, the direct electrical connection of the longitudinal edges of the current collectors to the end faces of the housing reduces the internal resistance of the cell, so that the occurrence of large currents can be better absorbed. In addition, heat can be better dissipated from the winding-shaped electrode-separator assembly.

The further measure provided for, namely that the longitudinal edges of the electrodes are electrically connected to the end face elements of the housing in such a way that the longitudinal edges are welded to inwardly projecting regions of the housing cup base or the lid, firstly facilitates the manufacturing process, in particular with regard to mass production. On the other hand, this enables a particularly stable and reliable connection between the respective end face element of the housing and the longitudinal edge of the respective electrodes.

The elevation and/or deformation region can, for example, be a region in which the thickness of the base of the housing cup or the lid is increased, compared to the average thickness of the base or the lid. In some preferred embodiments, the elevation is located exclusively on the inside and is not visible from the outside. However, preferably the elevation and/or deformation region is a deformation of the base of the housing cup or the lid pointing into the interior space.

Overall, the at least one elevation and/or deformation region allows a particularly good direct electrical connection to the respective first longitudinal edge of the current collectors and thus of the electrodes.

Both the housing cup and the lid preferably consist of a sheet metal. The sheet metal can be a sheet of steel or a sheet of nickel-plated steel, for example. Sheets made of aluminum or copper are also possible.

It is preferred that the lid has a wall thickness in the range from 0.05 mm to 1.5 mm, preferably from 0.1 mm to 1.0 mm, more preferably from 0.1 mm to 0.5 mm, still more preferably from 0.15 mm to 0.3 mm, alternatively in the range from 0.08 mm to 0.2 mm. This applies in particular to the region of the lid in which the first longitudinal edge of the anode current collector or the first longitudinal edge of the cathode current collector abuts directly against the inner side.

It is preferred that the housing cup has a wall thickness in the range from 0.05 mm to 1.5 mm, preferably from 0.1 mm to 1.0 mm, more preferably from 0.1 mm to 0.5 mm, even more preferably from 0.15 mm to 0.3 mm, alternatively in the range from 0.08 mm to 0.2 mm. This applies in particular to the base of the housing cup.

In a preferred embodiment of the energy storage cell, it is characterized by at least one of the immediately following additional features a. to c.:
a. The first longitudinal edge protruding from the first terminal end face and/or from the second terminal end face of the electrode-separator assembly, which edge abuts directly against the inner side of the housing cup base or of the lid, is deformed in at least one depression region.
b. The at least one depression region corresponds to the at least one region in which the housing cup base or the lid has a deformation pointing into the interior space or in which the elevation of the housing cup base or the lid projects into the interior space.
c. The deformation or elevation pointing into the interior space is pushed or pressed into the at least one depression region.

Preferably, the directly above-mentioned features a. and b. or, preferably, the directly above-mentioned features a., b. and c. are realized in combination.

In these preferred and advantageous embodiments, the winding-shaped electrode-separator assembly thus has one or more depression regions on one or both end faces, which correspond to the at least one elevation and/or deformation region.

In this context, the term “corresponding” is preferably to be understood as meaning that the elevation and/or deformation areas protrude directly into the corresponding depression regions on the end face(s) of the winding.

The elevation and/or deformation regions which protrude into the depression regions result in an optimized mechanical contact between the respective portions of the longitudinal edges of the current collectors and the at least one elevation and/or deformation region, so that reliable welding of the current collectors to the housing parts is possible. And also very important: The combination of the depression regions and elevation and/or deformation regions which can protrude into the depression regions can facilitate correct positioning of the winding in a housing part during production.

The at least one depression region can be formed by a deformation of the protruding longitudinal edges of the respective current collectors on the end face(s) of the winding. When deforming the longitudinal edge of the respective current collector, the longitudinal edge is preferably subjected to a directed deformation and can, for example, be bent or folded in a defined direction. Investigations have shown that such pretreatment or deformation of the winding at the corresponding points of the end face region of the winding can significantly improve the electrical contact between the housing cup base or the lid and the respective current collector edge and facilitate welding.

With regard to the embodiment of the at least one elevation and/or deformation region, in preferred embodiments at least one of the immediately following additional features a. and b. is provided:
a. The deformation pointing into the interior space is designed as a bead.
b. The bead appears on an external side of the housing cup base and/or an external side of the lid as a depression, in particular as an elongated depression, and on an internal side of the housing cup base and/or the lid as an elevation, in particular as an elongated elevation.

Preferred are the directly aforementioned features a. and b. realized in combination with each other.

Beads can be produced very easily, for example by embossing or other forming processes. The wall thickness of the housing element in the region of the bead is, as already indicated above, preferably constant. Further details on this are explained below in connection with the manufacturing process of the cells.

Preferably, the deformation pointing into the interior space, in particular the bead, has a length in the range from 2 mm to 12 mm, preferably from 2 mm to 8 mm, and a width in the range from 0.5 mm to 4 mm, preferably from 1 mm to 3 mm, preferably from 1 mm to 2.5 mm. This applies to all embodiments of the deformations disclosed herein.

The absolute length and width of the deformation is adapted to the dimensions of the energy storage element.

Preferably, the deformation is longer than it is wide by a factor in the range from 2 to 20, preferably in the range from 4 to 12.

In preferred embodiments, the energy storage cell is characterized by at least one of the immediately following additional features a. and b:
a. In the at least one region in which the housing cup base or the lid has a deformation pointing into the interior space or in which an elevation of the housing cup base or the lid protrudes into the interior space, there are one or more welding marks, in particular three weld seams.
b. In the at least one region in which the housing cup base or the lid has a deformation pointing into the interior space or in which an elevation of the housing cup base or the lid projects into the interior space, there are two or more parallel weld seams, in particular three parallel weld seams.

Preferably, the directly aforementioned features a. and b. are realized in combination with each other.

The welding marks can consist of weld spots or of a seam formed of weld spots or of a continuous weld seam, for example generated by laser welding. The welding marks can also be or comprise impressions of welding electrodes on the outside of the base of the housing cup or the lid.

The welding marks, in particular the weld seams or weld spots, are generated when the first longitudinal edge of the anode current collector or the cathode current collector is welded to the housing cup base or to the lid, for example by passing a strong current through the longitudinal edge and the housing cup base or the lid in order to heat the longitudinal edge and the housing cup base or the lid locally to such an extent that they melt. The welding marks, in particular the weld seams or weld spots, are preferably visible on the external side of the housing cup base or lid.

Preferably, the weld seams or weld spots are produced by a laser. Otherwise for example welding by applying an electric current (resistance welding) is a suitable choice.

Welding is preferably carried out from the outside. In the case of the laser, it first penetrates the housing cup base or lid before melting the current collector. In the case of welding using an electric current, the required welding electrodes are preferably used on the external side of the housing cup base or lid to effect the welding. This is efficient if the electrical conductivity of the current collector is higher than the electrical conductivity of the housing cup base or lid.

As already mentioned above, the weld seams can also be realized by a series of adjacent welding spots, which are advantageously close together. In other embodiments, a continuous weld seam or several continuous weld seams can also be provided.

In preferred embodiments, the energy storage cell is characterized by at least one of the immediately following additional features a. to c.:
a. The deformation in the housing cup base or lid facing into the interior space is formed as a linear bead.
b. The housing cup base and/or lid comprises several linear beads, preferably three linear beads.
c. The three beads are arranged in a star shape, with neighboring beads forming an angle of 120°.

In a preferred manner, the directly aforementioned features a. and b. or, preferably, the aforementioned features a., b. and c., are realized in combination with one another.

Preferably the welding marks are positioned in the deformation or beads, preferably in the deepest region of the deformation or the beads.

In principle, the at least one elevation and/or deformation region can also be realized in a different form and/or fewer or more than three beads can be provided, for example, five or seven beads can also be provided. The specific embodiment and geometry of the at least one elevation and/or deformation region and, in particular, of the beads is suitably adapted to the size and dimensions of the button cell or the energy storage cell. For example, three or more beads arranged in a star shape, wherein the beads are evenly distributed over the surface of the respective end face of the button cell, are suitable for commercially available designs of button cells. In this way, a uniform electrical connection of the respective electrodes to the end faces of the button cell can be achieved.

In preferred embodiments of the energy storage cell or the button cell, the cell is characterized in that it has one or more deformations or beads in the housing cup base and/or the lid, the depth of which is in the region from 0.05 mm to 0.60 mm, preferably from 0.10 mm to 0.50 mm, more preferably from 0.20 mm to 0.40 mm. A depth of approx. 0.30 mm is preferred.

In preferred embodiments, the energy storage cell or the button cell is further characterized in that it has a winding-shaped electrode-separator assembly which has one or more of the depression regions in the region of one or both of its end faces. Their depth can in particular be in the region from 0.05 to 0.45 mm, preferably from 0.15 mm to 0.35 mm, more preferably of approx. 0.25 mm.

Preferably, the dimensions of the depression regions correspond to the dimensions of the elevation and/or deformation areas.

The direct connection of the longitudinal edges of the current collectors to the housing can be provided on one or both end faces of the electrode-separator assembly.

If the connection is only provided on one end face, only the longitudinal edge of the anode current collector or only the longitudinal edge of the cathode current collector must have a free edge strip protruding from the corresponding end face of the electrode-separator assembly. The other electrode can, for example, be electrically contacted in a manner known per se, in particular by means of a separate arrester, for example by means of a strip-shaped metal foil which is welded to the respective current collector.

Accordingly, in a first basic embodiment of the energy storage cell, the described electrical connection of the electrodes by welding the first current collector edge to the at least one elevation and/or deformation region is only realized on one side of the electrode-separator assembly. In this embodiment, the energy storage cell is characterized in particular by at least one of the immediately following features a. to d.:
a. The first longitudinal edge of the anode current collector or the first longitudinal edge of the cathode current collector abuts the inside of the housing cup base or the inside of the lid.
b. The housing cup base or the lid have at least one region in which the housing cup base or the lid has a deformation pointing into the interior space or in which an elevation of the housing cup base or the lid protrudes into the interior space.
c. The first longitudinal edge of the anode current collector or the first longitudinal edge of the cathode current collector is welded to the deformation or to the elevation.
d. The current collector that is not welded to the deformation or the elevation is electrically connected to one of the housing parts via an electrical conductor, in particular via a strip-shaped electrical conductor, for example a strip-shaped metal foil conductor.

Preferably, the directly aforementioned features a., b. and c. are realized in combination. In a preferred manner, the directly aforementioned features a. to d. are realized in combination.

In a further preferred embodiment of the energy storage cell, the described electrical connection of the electrodes is located directly to the housing on both sides of the energy storage cell by welding the longitudinal edges of the electrode strips. Accordingly, in preferred embodiments, the energy storage cell is characterized by at least one of the immediately following additional features a. to c.:
a. The first longitudinal edge of the anode current collector or the first longitudinal edge of the cathode current collector abuts against the inside of the housing cup base and the first longitudinal edge of the current collector not abutting against the inside of the housing cup base abuts against the inside of the lid.
b. Both the housing cup base and the lid each have at least one region in which they have a deformation pointing into the interior space or in which an elevation of the housing cup base or of the lid projects into the interior space.
c. The first longitudinal edge of the anode current collector and the first longitudinal edge of the cathode current collector are each welded to a deformation or elevation.

Preferably, the directly aforementioned features a., b. and c. are realized in combination.

The housing of the energy storage cell can, apart from the described features, be realized as in conventional button cells.

For example, the immediately following features a. and b. may be provided with regard to the design of the housing:
a. Like the housing cup, the lid is cup-shaped and has a lid base, a circumferential side wall and an opening edge, wherein the lid is pushed into the housing cup with the opening edge first.
b. The housing cup and the lid are separated from each other by an annular, electrically insulating seal.

Preferably, the directly aforementioned features a. and b. are realized in combination.

In these cases, it is preferred that the lid base has the at least one region with the deformation pointing into the interior space or in which an elevation of the lid protrudes into the interior space of the housing.

The annular seal can consist of a plastic commonly used to seal electrochemical cells, for example polyamide or a polyether ketone.

In another embodiment of the housing of the energy storage cell, at least one of the immediately following features a. to c. may be realized:
a. The lid is a disk which is inserted into the terminal opening of the cup-shaped housing part.
b. The disk is welded into the opening of the cup-shaped housing part.
c. An electrical pole is passed through the disk, which is electrically insulated from the disk and is electrically connected to one of the electrodes.

Preferably, the directly above-mentioned features a., b. and c. are realized in combination.

The energy storage cell is preferably a lithium-ion cell. Accordingly, the electrode materials with which the current collectors are charged are preferably conventional electrode materials for lithium-ion cells. Preferably, the energy storage cell comprises an electrolyte commonly used for lithium-ion cells.

Within the electrode-separator assembly, the anode and the cathode are separated from each other by at least one separator. The separator is preferably ribbon-shaped. It can consist of a microporous plastic film or a fleece, for example.

In some embodiments, the electrodes in the electrode-separator assembly can also be connected to each other via a layer of a solid electrolyte. This layer then also serves as a separator. A liquid electrolyte is not mandatorily necessary in these cases.

The housing cup base of a preferred embodiment of the energy storage cell is preferably provided for contacting the anode. The anode current collector preferably consists of copper or a copper alloy, in particular copper foil. The cathode current collector preferably consists of aluminum or an aluminum alloy, in particular aluminum foil.

The energy storage element preferably has a maximum height ≤1.5 cm and a maximum diameter ≤2.5 cm.

The present disclosure further provides a method of manufacturing an electrochemical energy storage cell in the form of a button cell, in particular in the form of a button cell having the features described above. This method always comprises the following steps:
a. Providing a metallic, cup-shaped housing part which comprises a housing cup base, a circumferential side wall and a terminal opening, wherein the housing cup base and the circumferential side wall each have an inner side and an outer side,
b. Providing a lid, wherein the lid has an internal side and an external side,
c. Providing an electrode-separator assembly in the form of a cylindrical winding which has a first flat terminal end face and a second flat terminal end face and a winding shell located between the end faces, wherein
i. the electrode-separator assembly comprises a ribbon-shaped cathode with a cathode current collector having a first longitudinal edge and a second longitudinal edge parallel thereto,
ii. the electrode-separator assembly comprises a ribbon-shaped anode with an anode current collector having a first longitudinal edge and a second longitudinal edge parallel thereto, and wherein,
iii. the anode current collector comprises a main region which is loaded with a layer of negative electrode material and a free edge strip which extends along its first longitudinal edge and which is not loaded with the electrode material,
and/or
the cathode current collector comprises a main region loaded with a layer of positive electrode material and a free edge strip extending along its first longitudinal edge which is not loaded with the electrode material, and
iiii. the anode and the cathode are arranged within the electrode-separator assembly in such a way that the first longitudinal edge of the anode current collector protrudes from the first flat terminal end face and/or the first longitudinal edge of the cathode current collector protrudes from the second flat terminal end face of the electrode-separator assembly,
d. Inserting the electrode-separator assembly into the housing part so that the winding is axially aligned in the housing to be formed and one of the end faces of the winding faces the housing cup base, and
e. Closing the cup-shaped housing part using the lid and, if appropriate, an annular, electrically insulating seal to form an airtight and liquid-tight housing with an interior space in which the electrode-separator assembly is arranged, wherein, after closure, the first longitudinal edge of the anode current collector and/or the first longitudinal edge of the cathode current collector abuts against the inside of the housing cup base and/or against the inside of the lid, wherein.
f. At least one deformation is introduced into the housing cup base and/or the lid, which points into the interior space when the housing is closed,
or
the housing cup base or the lid provided have at least one protrusion that protrudes into the interior space after the housing is closed, and
g. The first longitudinal edge of the anode current collector or the cathode current collector abutting on the inside of the housing cup base or on the inside of the lid is welded to the deformation or to the elevation.

The lid and the housing cup base of the cup-shaped housing part can be provided with the at least one deformation or the at least one elevation. For example, the lid and the housing cup base can be produced from a sheet material which already has the at least one deformation or the at least one elevation. However, it is also possible to introduce the deformation into the lid or housing cup base at a later stage, for example before step d. The deformation is preferably introduced by a stamping process or by a conventional forming process, which can be incorporated into the process of manufacturing the lid or the cup-shaped housing part.

Both the lid and the cup-shaped housing part as well as the elevation, the deformation, the electrode-separator assembly and also the welding marks created during welding have been described above in connection with the electrochemical energy storage cell. Reference is hereby made to the corresponding explanations.

Reference is also made to the preferred embodiments described in connection with the energy storage cell, such as the depression regions into which the deformation or the elevation protrudes.

The winding-shaped electrode-separator assembly can first be inserted into the cup-shaped housing part. Then the welding of the respective longitudinal edge of the electrode can take place in the region of the housing cup base before the housing cup is closed with the lid.

However, welding can also take place after the housing has been closed, wherein welding from the outside is then required. Welding from the outside can be achieved for example by resistance welding or laser welding.

Further features and advantages of the invention are apparent from the following description of preferred examples in conjunction with the drawings. Generally, the illustrated features of the cell can be realized separately or in combination with other illustrated features.

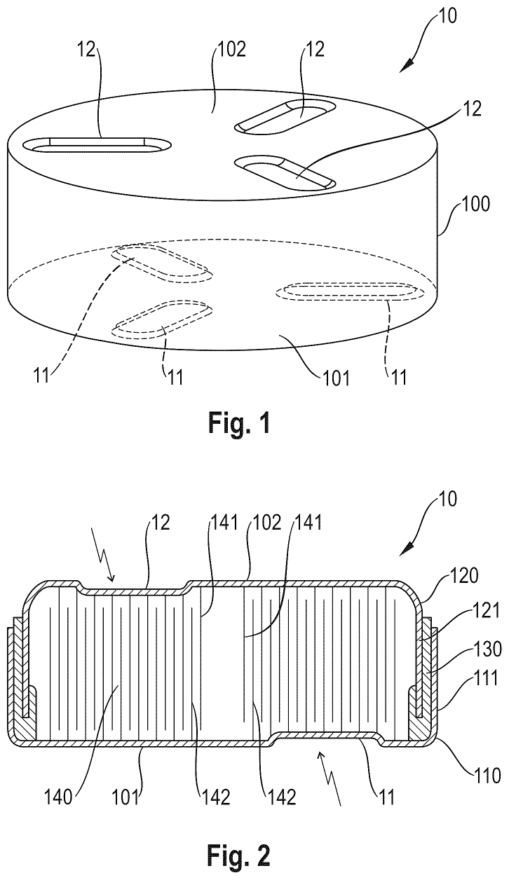

FIG. 1 shows an exemplary embodiment of an energy storage cell in the form of a button cell 10, wherein the focus of the illustration here is on the housing 100 and the interior of the cell is therefore not shown. The cylindrical housing 100 has a housing cup base 101 and a lid base 102. In this embodiment, the housing cup base 101 and the lid base 102 each have three deformations 11, 12 pointing into the interior space of the cell in a star-shaped arrangement. These deformations 11, 12 are formed as beads, which appear as elongated depressions on the external side of the housing cup base 101 or the lid base 102 and as elongated elevations on the internal side of the housing cup base 101 or the lid base 102.

FIG. 2 shows a sectional view of a button cell having a housing with beads like the button cell housing according to FIG. 1, wherein the section is laid through one of the beads 11 in the housing cup base and through one of the beads 12 in the lid base 102.

The housing of the cell 10 comprises a metallic, cup-shaped housing part 110 with the housing cup base 101 and a circumferential side wall 111, the terminal edge of which defines a terminal opening. Furthermore, the housing comprises a metallic, cup-shaped lid 120 with the lid base 102 and a circumferential side wall 121. The lid 120 is inserted into the housing part 110, wherein the respective circumferential side walls 111 and 121 and thus also the housing parts 110 and 120 are electrically insulated from each other by a seal 130.

The schematically illustrated winding-shaped electrode-separator assembly 140 is located inside the housing of the button cell 10. The electrode-separator assembly 140 is formed by a ribbon-shaped anode 142 and a ribbon-shaped cathode 141. Within the electrode-separator assembly 140, the anode 142 and the cathode 141 are separated from each other by a ribbon-shaped separator, which is not shown here. The anode 142 and the cathode 141 are each formed by a current collector coated with electrode material (also not shown). In this embodiment, both the anode 142 and the cathode 141 or their current collectors each have a first longitudinal edge that is not coated with the electrode material. The free first longitudinal edge of the cathode 141 protrudes from the upper end face of the wraparound electrode-separator assembly 140 shown in this embodiment. The free first longitudinal edge of the anode 142 protrudes from the lower end face of the electrode-separator assembly 140. Electrical contact of the electrodes with the housing cup base 101 or with the lid base 102 is made via these free longitudinal edges of the current collectors, in that free edge strips or first longitudinal edges of the current collectors abutting on the inside of the housing cup base 101 or on the inside of the lid base 102 are welded to the elevations 11 of the housing cup base 101 pointing into the interior space or to the elevations 12 of the lid base 102 pointing into the interior space. The welding region is indicated by arrows in this illustration.

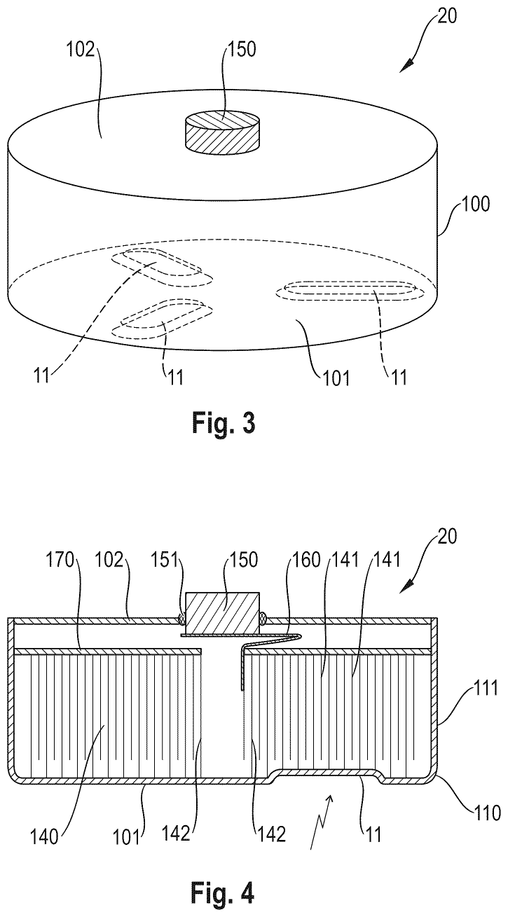

FIG. 3 shows a further embodiment of a button cell 20, wherein, as in FIG. 1, the focus of the illustration is on the housing 100, wherein the electrode separator-assembly is not shown. In this example, only the metal housing base 101 is provided with three beads 11. In contrast, a pole 150 is provided in the region of the lid base 102 of the button cell 20, which in this example embodiment leads the positive connection contact of the cell 20 to the outside. Of course, the polarity of the cell can also be the other way around.

FIG. 4 shows a sectional view of a button cell with beads and a pole 150 as in the button cell according to FIG. 3. The cell 20 comprises a metallic, cup-shaped housing part 110 with the housing cup base 101 and the circumferential side wall 111. In this example, the lid is formed by a metallic disc 102. This disk is inserted into the terminal opening of the cup-shaped housing part 110 and fixed therein by welding circumferentially. The disk-shaped lid base 102 has a central aperture through which the electrical pole 150 is guided. The pole 150 is electrically insulated from the disk or the lid base 102 by means of insulation 151.

The cathode 141 is electrically connected via a strip-shaped arrester 160, which connects the strip-shaped cathode 141 to the pole 150. In this example, the end face of the electrode-separator assembly 140 shown above is insulated from the lid base 102 and the arrester 160 by a disk-shaped insulating element 170. This can be, for example, an insulating disk or a foil. This insulating element 170 comprises a central hole through which the arrester 160 is guided in order to be able to contact the cathode 141 inside the electrode-separator assembly 140.

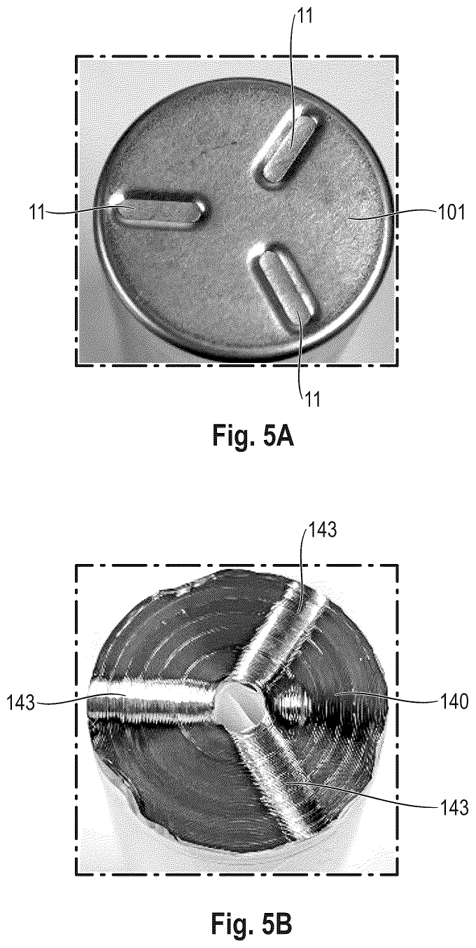

FIG. 5A shows a photographic representation of the housing cup base 101 of an energy storage cell. The three beads 11 are clearly visible, the elevated side of which protrudes into the interior space of the cell. In these regions inside the cell, contact is made by welding with the respective longitudinal edge of the current collector of the anode or the cathode of the electrode-separator assembly.

FIG. 5B shows a photographic view of a winding-shaped electrode-separator assembly 140, wherein one of the end faces of the winding has three depression regions 143, which correspond to the channel-shaped depressions 11 of FIG. 5A. These depression regions 143 can be produced by mechanically deforming the end faces of the winding. By means of this opposite shaping of the winding and the corresponding housing part, the precision and reliability of the electrical connection is optimized, namely by welding in these regions. In addition, with the help of these depression regions 143, the positioning of the winding within the housing to be assembled can be simplified by alignment using the protruding regions of the housing cup base or, if applicable, the lid base.

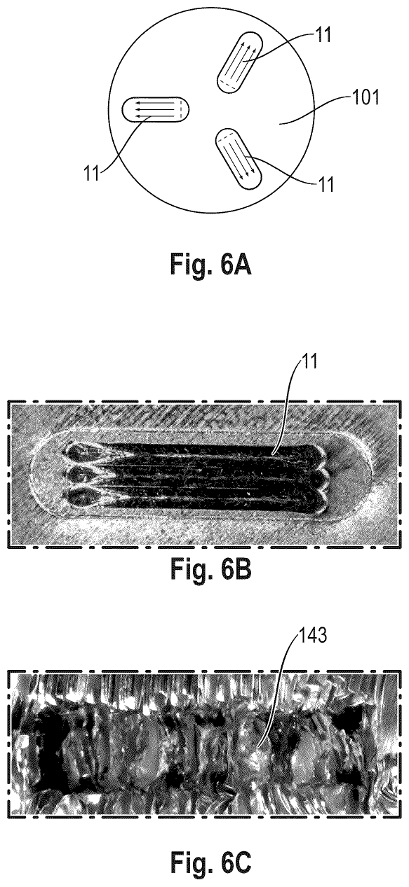

FIG. 6A shows a possibility to connect the respective longitudinal edges of the current collectors to the housing cup base or to the lid base. FIG. 6A schematically shows a housing cup base 101 with three elongated depressions 11 which project into the interior space of the housing. Three arrows are shown in each of the three depressions 11 to illustrate the weld seams to be formed.

FIG. 6B shows a microscopic view of one of the channel-shaped depressions 11 with the three weld seams formed therein. FIG. 6C shows a microscopic view of a corresponding depression region 143 in the end face of a winding-shaped electrode-separator assembly.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An electrochemical energy storage cell in the form of a button cell, the electrochemical energy storage cell comprising:
a housing that encloses an interior space in an airtight and liquid-tight manner, the housing comprising:
a metallic, cup-shaped housing part that comprises a housing cup base, a circumferential side wall, and a terminal opening, wherein the housing cup base and the circumferential side wall each have an inner side facing the interior space and an outer side,
a lid that closes the terminal opening of the cup-shaped housing part, wherein the lid has an inner side facing the interior space and an outer side,
an electrode-separator assembly in the form of a cylindrical winding having a first flat terminal end face, a second flat terminal end face, and a winding shell located between the end faces, the electrode-separator assembly comprising:
a ribbon-shaped anode comprising an anode current collector having a first longitudinal edge and a second longitudinal edge parallel thereto,
a ribbon-shaped cathode comprising a cathode current collector having a first longitudinal edge, a second longitudinal edge parallel to the first longitudinal edge,
wherein the anode current collector comprises a main region loaded with a layer of negative electrode material and a free edge strip, which extends along the first longitudinal edge of the anode current collector, not loaded with the negative electrode material and/or the cathode current collector comprises a main region loaded with a layer of positive electrode material and a free edge strip, which extends along the first longitudinal edge of the cathode current collector, not loaded with the positive electrode material,
wherein the anode and the cathode are arranged within the electrode-separator assembly such that the first longitudinal edge of the anode current collector protrudes from the first terminal end face and/or the first longitudinal edge of the cathode current collector protrudes from the second terminal end face,
wherein the electrode-separator assembly is axially aligned in the housing so that one of the first or the second terminal end face faces the housing cup base and the other of the first or the second terminal end face faces the lid,
wherein the first longitudinal edge of the anode current collector or the first longitudinal edge of the cathode current collector abuts directly against a respective inner side, the respective inner side being the inner side of the housing cup base or the inner side of the lid,
wherein the respective inner side includes a region having a projection directed into the interior space, and
wherein the first longitudinal edge of the anode current collector or the first longitudinal edge of the cathode current collector that abuts directly on the respective inner side is welded to the projection.

2. The energy storage cell of claim 1, wherein at least one of:
the first longitudinal edge of the anode current collector or the first longitudinal edge of the cathode current collector that abuts directly against the respective inner side is deformed in a depression region;
the depression region corresponds to the projection; and/or
the projection is pushed or pressed into the depression region.

3. The energy storage cell according to claim 1, wherein at least one of:
the projection is designed as a bead; and/or
the bead appears on an external side of the housing as an elongated depression and on an internal side of the housing cup base and/or an internal side of the lid as an elongated elevation.

4. The energy storage cell according to claim 1, wherein at least one of:
the depression region includes a weld mark; and/or
the depression region includes two or more parallel weld seams.

5. The energy storage cell according to claim 1, wherein at least one of:
the projection is formed as a linear bead;
the housing cup base and/or the lid comprises a plurality of linear beads; and/or
the plurality of linear beads on the housing cup base and/or the lid are arranged in a star shape with neighboring beads forming an angle of 120°.

6. The energy storage cell according to claim 1, wherein at least one of:
the first longitudinal edge of the anode current collector or the first longitudinal edge of the cathode current collector that abuts directly against the respective inner side is welded to the projection; and/or
the other of the anode current collector or the cathode current collector that is not welded to the projection is electrically connected to the housing via an electrical conductor.

7. The energy storage cell according to claim 1, wherein at least one of:
the respective inner side is the inner side of the housing cup base;
the lid includes a second region including a second projection directed into the interior space; and/or
the first longitudinal edge of the anode current collector and the first longitudinal edge of the cathode current collector are each welded to one of the projection or the second projection.

8. The energy storage cell according to claim 1, wherein at least one of:
the lid is cup-shaped and includes a lid base, a circumferential side wall, and an opening edge, wherein the lid is pushed into the housing cup with the opening edge first; and/or
the housing cup and the lid are separated from each other by an annular, electrically-insulating seal.

9. The energy storage cell according to claim 1, wherein at least one of:
the lid is a disk inserted into the terminal opening of the cup-shaped housing part;
the disk is welded into the terminal opening of the cup-shaped housing part; and/or
an electrical pole is passed through the disk, the electrical pole being electrically insulated from the disk and being electrically connected to one of the electrodes.

10. A method of manufacturing an electrochemical energy storage cell, the method comprising:
providing a metallic, cup-shaped housing part that comprises a housing cup base, a circumferential side wall and a terminal opening, wherein the housing cup base and the circumferential side wall each have an inner side and an outer side,
providing a lid, wherein the lid has an internal side and an external side,
providing an electrode-separator assembly in the form of a cylindrical winding that comprises a first flat terminal end face, a second flat terminal end face, and a winding shell located between the end faces, wherein the electrode-separator assembly comprises:
a ribbon-shaped cathode with a cathode current collector having a first longitudinal edge and a second longitudinal edge parallel thereto, and
a ribbon-shaped anode with an anode current collector having a first longitudinal edge and a second longitudinal edge parallel thereto, and wherein
inserting the electrode-separator assembly into the housing part so that the cylindrical winding is axially aligned such that the first flat terminal end face or the second flat terminal end face faces the housing cup base,
closing the cup-shaped housing part using the lid and forming an airtight and liquid-tight housing with an interior space in which the electrode-separator assembly is arranged,
wherein the anode current collector comprises a main region loaded with a layer of negative electrode material and a free edge strip, which extends along the first longitudinal edge of the anode current collector, not loaded with the negative electrode material and/or the cathode current collector comprises a main region loaded with a layer of positive electrode material and a free edge strip, which extends along the first longitudinal edge of the cathode current collector, not loaded with the positive electrode material,
wherein the anode and the cathode are arranged within the electrode-separator assembly such that the first longitudinal edge of the anode current collector protrudes from the first terminal end face and/or the first longitudinal edge of the cathode current collector protrudes from the second terminal end face,
wherein, after closure, the first longitudinal edge of the anode current collector and/or the first longitudinal edge of the cathode current collector abuts against the inner side of the housing cup base and/or against the inner side of the lid,
wherein at a projection directed into the interior space when the housing is closed is provided on the housing cup base or on the lid, and
wherein the first longitudinal edge of the anode current collector or the first longitudinal edge of the cathode current collector is welded to the projection.
